(19) United States
(12) Patent Application Publication
(10) Pub. No.: US 2014/0024347 A1
(43) Pub. Date: Jan. 23, 2014

(54) Wireless Device Driving Deactivation System and Support

(71) Applicant: Mike Carter, Oakdale, MN (US)

(72) Inventor: Mike Carter, Oakdale, MN (US)

(21) Appl. No.: 13/945,711

(22) Filed: Jul. 18, 2013

Related U.S. Application Data
(60) Provisional application No. 61/672,871, filed on Jul. 18, 2012.

(51) Int. Cl. H04B 1/38

(52) U.S. Cl. CPC H04B 1/3822
USPC 455/413; 455/575.9

(57) ABSTRACT

A wireless device deactivation system is provided that charges the wireless device while securing the same within a lockable support, preventing physical access to the device while blocking notifications to the user when a phone call or incoming message is received. The device comprises a support having a connector that charges the wireless device and communicates therewith to lock the device screen and to deactivate notifications. When a message is received, unique senders will be given a message that the user is otherwise preoccupied and cannot receive the message. Similarly, when a phone call is received, the call is directed to a voice mail system for the sender to leave a message for later retrieval. The system receives power from the vehicle and includes a support base having electrical components to function with common wireless devices, whereby the device does not distract the driving user when attached to the system.

### CROSS REFERENCE TO RELATED APPLICATION

This application claims the benefit of U.S. Provisional Application No. 61/672,871 filed on Jul. 18, 2012, entitled “Cell Safe.” The above identified patent application is herein incorporated by reference in its entirety to provide continuity of disclosure.

### BACKGROUND OF THE INVENTION

1. Field of the Invention

The present invention relates to wireless devices and safety systems for wireless device users in motor vehicles. More specifically, the present invention pertains to a wireless device charger system that locks the device and blocks notifications to the user of any incoming messages, while notifying incoming callers and messengers of their attempt to connect with the intended recipient is being blocked, whereby the sender is told the recipient is driving and cannot answer the call or message.

Many users engage in cellular phone use while operating a motor vehicle. This practice has been highly scrutinized in recent years, as the proliferation of wireless devices has greatly expanded and correspondingly the number of vehicle accidents that have been attributed to distracted driving has increased therewith. Operating a cellular phone requires one to divert attention from the road when visualizing the device screen, and further requires manual input when holding the device against the caller's ear or when making touch inputs on the device to navigate screens when typing out messages. This diversion of attention and a free hand can greatly interfere with one's ability to drive at full capacity, and has led to many accidents and deaths in the United States.

Most Americans drive during the course of the day, either for commuting purposes, for running errands, or for leisure driving trips. Driving a vehicle, particularly on crowded roads, windy roads, or at higher speeds, requires a driver's full attention to avoid road obstacles and to avoid collisions with other motorists. Cellular devices, while incredibly useful in everyday life for communication, navigation, and general information gathering, present a very serious distraction for a driver while operating a vehicle. This distraction can quickly become a danger to all motorists, where use of the phone is both hazardous and irresponsible on the part of the cellular phone user.

Many states have passed laws expressly forbidding cellular phone use while operating a vehicle, these include voice use and text message use. Hands free systems are very helpful for maintaining a user's attention on the road, but still create a form of distraction when communicating or when navigating through screens to answer a phone or send an outgoing call. The present invention pertains to a cellular phone deactivation system, whereby all use of the wireless device is prevented while the device is in connected to the system. Complete removal of the cellular phone from the user is the only sure means of preventing distractions to a driving user, and is the best way to prevent roadway injuries and fatalities as a result of distracted drivers using wireless devices.

The present invention provides a wireless device system that charges the wireless device while interacting with the same to cease operation of the screen and block any notifications to the driving user. When an incoming call or message is received, the system recognizes unique senders and responds with an appropriate message alerting the sender of the user's incapacity to answer while driving. Along with the system, the present invention further contemplates a physical support for the wireless device, which supports the same in a secure lockbox to prevent access thereto while driving. Overall, the system is provided for eliminating the ability of a driving user to respond to or initiate an outgoing a voice or text message while operating the motor vehicle, allowing users to abide local laws regarding cellular phone use and further for removing the urge to engage in cellular phone use while driving.

2. Description of the Prior Art

Devices have been disclosed in the prior art that relate to cellular phone systems and methods that deactivate the phone or send out automated messages. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

Devices in the prior art include systems and methods that are software-based and utilize the wireless device's onboard tools to determine a driving condition. The onboard GPS system, accelerometer, or cellular network are utilized to determine that a user is in a vehicle, and thereafter ceases certain operation of the device. While these devices are useful, they do nothing to physically secure the wireless device and prevent reactivation. These systems and methods further require the user to initiate the software or physically respond to an incoming message with a one-touch response. The present invention is directed to an automatic response system and phone screen/notification deactivation system, whereby the phone is charged and further secured within a housing that does not permit access while the user is driving. The present invention adds a layer of protection against use of the phone while driving, wherein input is not required by the user during the driving activity.

One such method in the prior art is U.S. Pat. No. 8,249,627 to Olincy, which discloses a method involving cellular phones and responding to an incoming call. An application on the phone or a keyed button thereon acts as a quick response for incoming messages and calls while driving or otherwise busy. The user, upon receiving a voice call or a text message, can depress a button on the screen or a button physically disposed on the phone to automatically respond to the sender with a message that the user is driving or otherwise occupied. While providing a means to quickly respond to one while driving, the Olincy device still requires user input and attention from the driver to operate, even if momentary. The present invention contemplates a system that automatically responds once the system is active, requiring no input from the user and completely separating the user from the phone while in the vehicle. The goal is to prevent any distractions for the user, either through active input or through push-button input while operating a vehicle.

An example of a system in the prior art related to cellular phone use is U.S. Patent Publication No. 2011/0137520 to Rector, which discloses a system that uses an in-vehicle network to determine an occupant's identity and then tailor the functions of the vehicle electronics to that user. The system allows parents to control features such as wireless use of cellular phones, the volume limit and operation of the vehicle stereo system, and other electrical features. One embodiment allows users to program the system to block incoming calls for certain drivers and respond with user-activated quick responses to the sender. Like the Olincy device, this system of response requires user input, and does not completely remove the phone from the potential driver. The present invention ceases the visual features of the wireless device, along with any notifications intended for the user, wherein incoming calls and messages are automatically responded to with a programmed message.

Yet another method is U.S. Patent Publication No. 2011/0207441 to Wood, which discloses a downloadable cellular phone application that detects motion in excess of a given threshold and deactivates all incoming notifications to the user. The application then sends a reply back to the sender that the recipient is driving. While providing a means to automatically respond, the Wood method is purely software based and requires the user to activate the program. The present invention contemplates a system that charges the wireless device while connecting the device to a system that deactivates the cellular phone screen, notifications, and automatically responds to incoming messages. The present system further contemplates a means of storing the wireless device within a structure that prevents driver interaction.

Finally, U.S. Pat. No. 8,135,123 to Moore discloses a method for responding to an incoming communication by determining the state of the recipient's device, retrieving a voice message that is associated with the sender's address, and sending an audible message from the send to a server. The method plays a stored voicemail message during the incoming call to respond to the communication. The Moore device, while providing a means to automatically respond to a sender, does not disclose the functional or physical elements of the system, nor does it address the specific goal of the present invention: preventing use while in a vehicle.

The present invention pertains to a new and novel system that engages a cellular phone, charging the same while blocking distracting features therefrom while the user is driving a motor vehicle. The system is an improved cellular phone stand that charges the phone, secures the device within a support, locks the phone display screen, and then blocks any notifications from the phone intended for the driving user. Message and incoming phone calls are intercepted and responded to automatically, alerting senders of the intended recipient's driving condition.

It is submitted that the present invention is substantially divergent in design elements from the prior art, and consequently it is clear that there is a need in the art for an improvement to existing wireless device driving systems. In this regard the instant invention substantially fulfills these needs.

### SUMMARY OF THE INVENTION

In view of the foregoing disadvantages inherent in the known types of wireless device vehicle systems now present in the prior art, the present invention provides a new wireless device charging, securing, and notification blocking system that can be utilized for providing convenience for the user when driving a vehicle in an un-distracted fashion and without interaction with a wireless device.

It is therefore an object of the present invention to provide a new and improved wireless device vehicle system that has all of the advantages of the prior art and none of the disadvantages.

It is another object of the present invention to provide a wireless device vehicle system that physically secures the wireless device while deactivating any notifications therefrom to the driving user.

Another object of the present invention is to provide a wireless device vehicle system that automatically responds to incoming messages and phone calls with a message that the user is preoccupied or is driving, wherein the sender is notified of the condition or is given a means to leave a voice message.

Yet another object of the present invention is to provide a wireless device vehicle system that locks the wireless device within a container that prevents access while driving, while also charging the wireless device while therein.

Another object of the present invention is to provide a wireless device vehicle system that functions with most smartphone and cellular phone devices, whereby the system causes the phone screen to lock and blocks vibratory, audible, and visual notifications otherwise sent to the user during normal operation.

Yet another object of the present invention is to provide a wireless device vehicle system that functions in conjunction with most modern cellular phone devices, wherein the phone coordinates with the system to achieve the desired operation while attached to the system.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of the system elements and the connection between the present system and a wireless device.

FIG. 2 shows the operational steps of the system when the wireless device is attached thereto.

FIG. 3 shows the operational steps when an incoming call is received while the wireless device is attached to the system.

FIG. 4 shows the operational steps when an incoming message is received while the wireless device is attached to the system.

FIG. 5 shows a pictorial view of the system in operation, including an example of the outgoing messages returned to a sender of a text message while the recipient is driving and the wireless device is attached to the system.

FIG. 6 shows an exemplary embodiment of the system and its support, wherein a wireless device is secured by the support and receives power from the vehicle through a removable electrical connection.

FIG. 7 shows the base of the present support, wherein the system elements are housed therein and the electrical connectivity is provided therealong.

### DETAILED DESCRIPTION OF THE INVENTION

Reference is made herein to the attached drawings. Like reference numerals are used throughout the drawings to depict like or similar elements of the wireless device vehicle system. For the purposes of presenting a brief and clear description of the present invention, the preferred embodiment will be discussed as used for securing a wireless device within a vehicle while a user is driving, and further for responding to incoming calls and messages with an automatic response. The figures are intended for representative purposes only and should not be considered to be limiting in any respect.

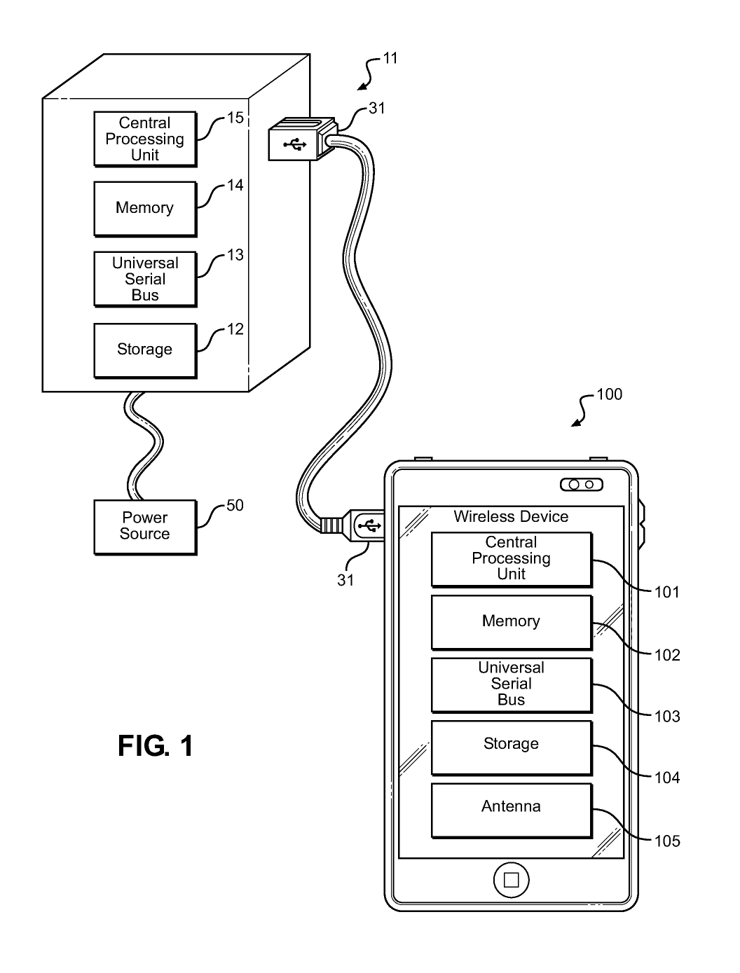

Referring now to FIG. 1, there is shown a view of the system elements of the present invention. The system comprises a wireless device support 11 that houses the electrical components of the present system, while further offering physical support and lockable containment of the wireless device 100 while a user is driving. Contemplated wireless devices include cellular phones, smartphone devices, tablet devices, and other electronic communication and entertainment devices that may serve as an active distraction for a driving user.

The support 11 includes a connection to a power source 50 and peripheral interface 13 between the support 11 and the wireless device 11, wherein the peripheral interface 13 is a connection means for the wireless device 100. This interface 13 is preferably a universal serial bus (USB) connection that provides a means of digital data transfer and power delivery between the system and the device 100 for charging the same and initiating the operation of the system commands (e.g. steps of the disclosed method). The connection to the power source 50 is either a removable DC connector that draws power from a power outlet within the vehicle interior (e.g. cigarette lighter receptacle or similar connection). Alternatively the electrical connection may comprise a hardwired connection to the vehicle battery or electrical system, wherein power can be drawn therefrom and the connection is not as readily removable by the user.

Within the system housing is an integrated circuit having a process means 15, a memory 14, and storage means 12. The processing means is preferably a central processing unit (CPU) that executes the commands stored within storage 12 for accomplishing the tasks of recognizing the wireless device 100 is thereconnected and thereafter executing the steps of the present invention in which the wireless device screen is locked, its notifications are stopped, and incoming messages and calls are diverted and responded to automatically. A USB connection 13 is provided for connecting the wireless device 100 to the housing 11 by way of an electrical connector 31, which transfers electrical power and commands from the system CPU 15.

The wireless device 100 comprises its own circuit and dedicated electrical components for operation as a phone and as an electronic handheld device (PDA, smartphone, etc.). The present system as shown in the housing 11 is adapted to coordinate with the system of the wireless device 100 for executing the commands that cease the distracting features of the device 100 while the user is driving. Specifically, the wireless device includes, at a minimum, a central processing unit 101, a memory 102, a USB connection 103, storage 104, and an antenna 105 for communicating to a wireless network.

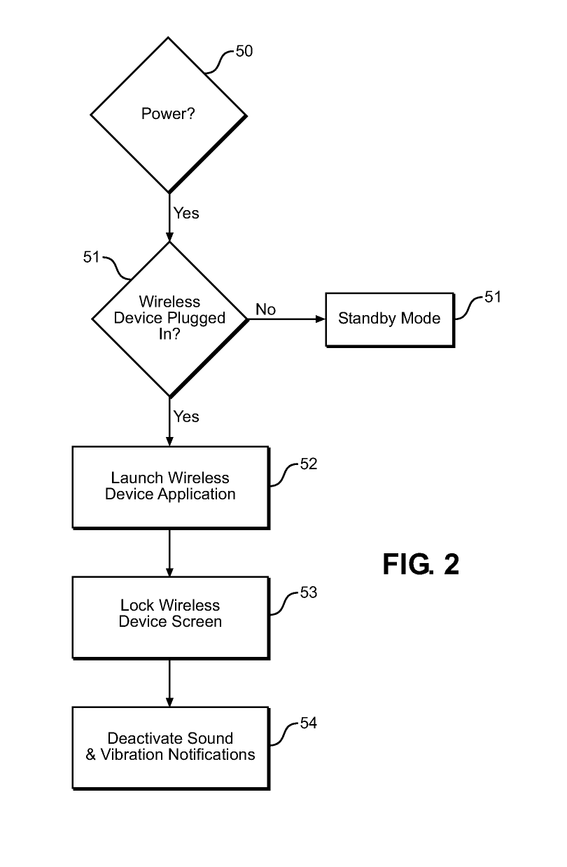

Referring now to FIG. 2, there is shown a flow diagram that outlines the steps the system takes and an outline of the code executed when the wireless device is attached to the system by way of the electrical connector. To operate the system, the housing is connected to a power source 50, either hardwired to the vehicle electrical system or plugged into a DC connector. Once powered, the system will be in standby mode 51 until a wireless device is plugged into the system 51, which occurs when a user has placed the wireless device in the housing support for the device and locked the same to prevent use while driving.

Once plugged in, the system operates in conjunction with an application 52 installed on the phone to secure the phone in a locked state 53 while thereconnected. The application executes commands or receives commands from the system to stops all audible, vibratory, or visual notifications to the user 54, and further to answer incoming messages and calls with a return message or voice message as an alternative to notifying the driving user. The return messages and voice message system allow senders to realize the recipient user is not actively answering their calls and messages because he or she is driving.

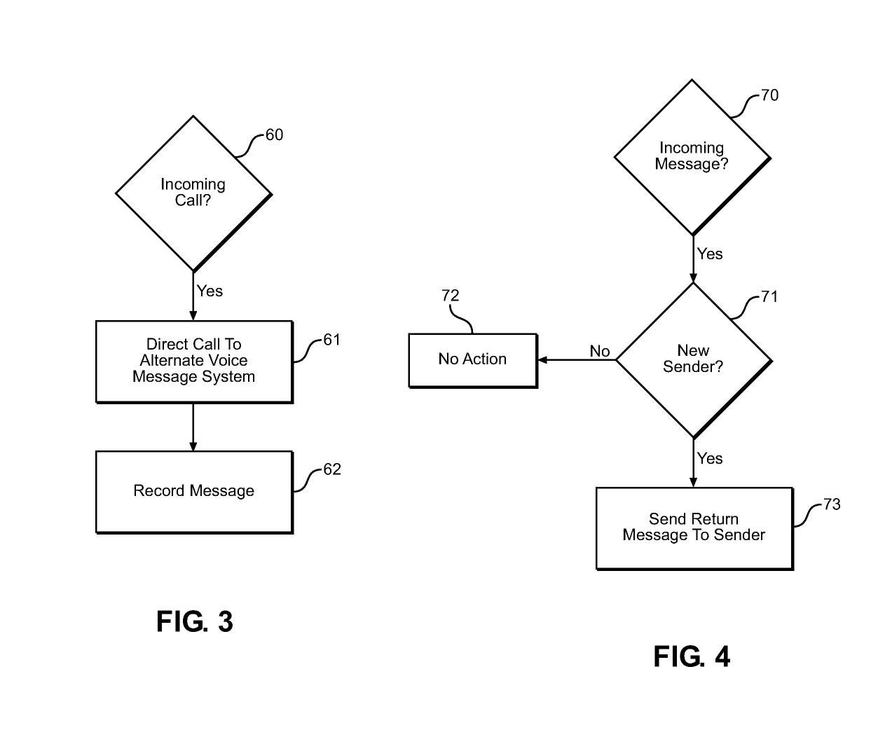

Referring now to FIG. 3 and FIG. 4, there are shown flow diagrams of the steps taken when a phone call or message is received by the wireless device when connected to the present system. The settings of the system message may be set to respond to SMS messages, email messages, or other messages received by cellular phone and smartphone devices. When an incoming call is received 60, the system executes commands to intercept the call and send the call to the phone's voice messaging system 61 or to an alternate voice message system that alerts the sender of a driving condition. The sender can then record a message on the voice message system 62 to be returned when the user is not driving.

Similarly to the incoming call, when an message is received 70, the system checks 71 to see if the sender is a unique sender or if the same user is sending several consecutive messages. For those users that are tagged as unique, the system responds with a return message 73 indicating the user is otherwise occupied or is driving and cannot respond. For those senders that not tagged as unique, no action 72 is taken, as the system has already responded with one message and several follow on messages would be redundant. After a given a time interval, the system resets the tracking of senders such that the same sender can be defined as unique after a given interval between sent message.

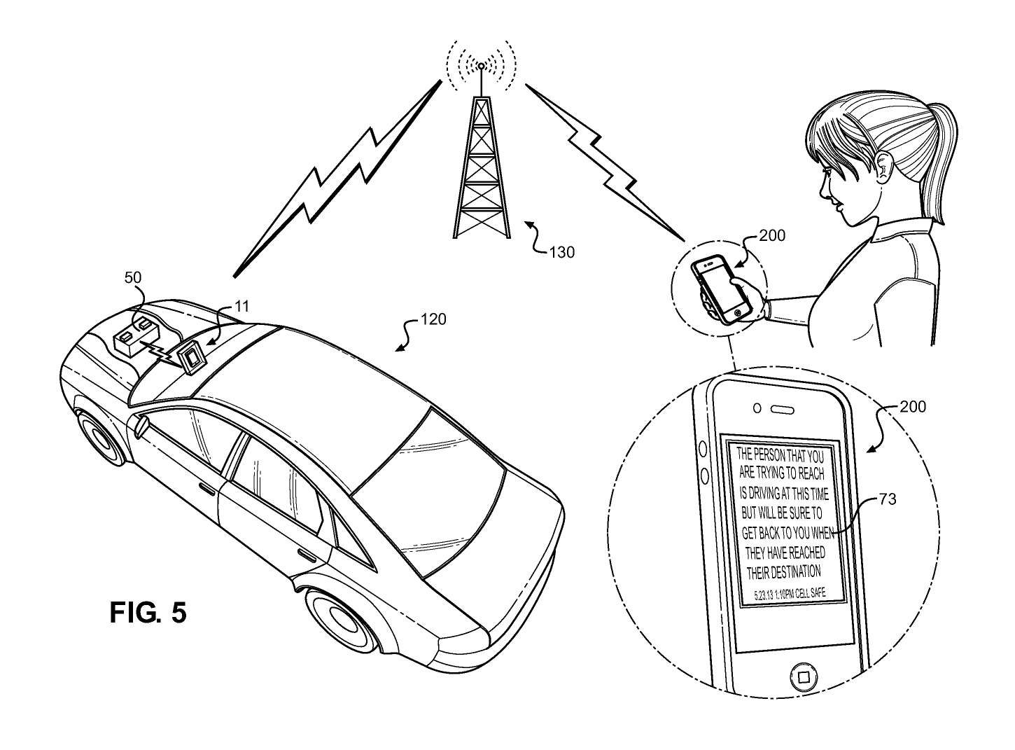

Referring now to FIG. 5, there is shown view of the system in operation with a vehicle 120, wherein a sender is attempting to communicate a message to the driving user who has connected the wireless device with the present system 11. When received, the system sends an automatic return message through a network 130, such as a cellular network, back to the sender's device 200. The return message 73 sent to the sender alerts her that the intended recipient is driving and cannot answer the call or read the message. It is desired to allow the system to be tailored to the user's preferences, including defining the return message 73, how to handle incoming calls (e.g. unique voice mail message, etc.), and defining what types of messages to return at all.

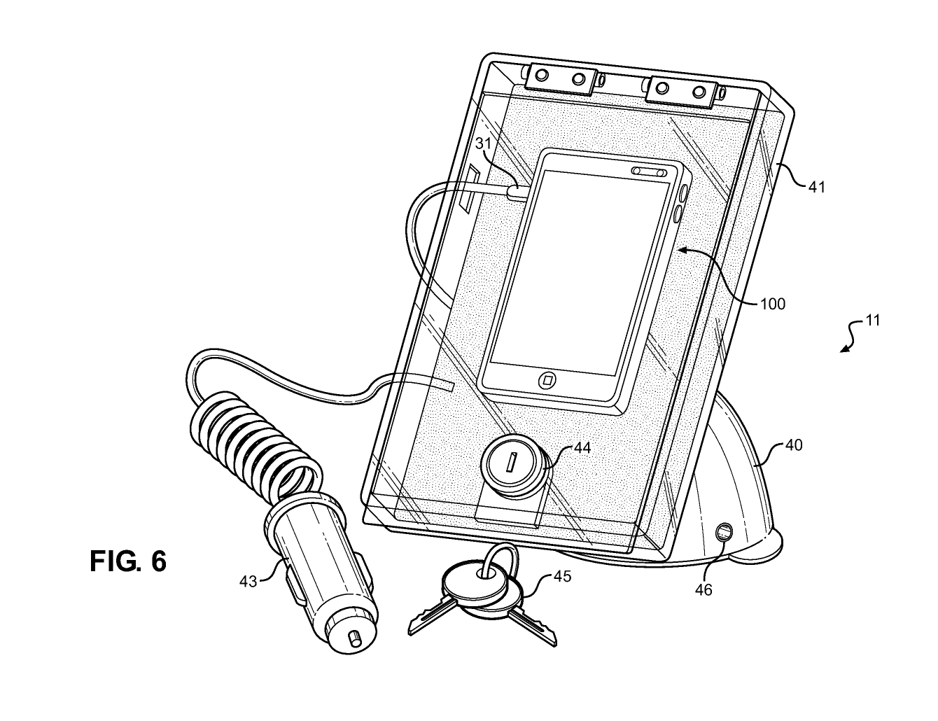

Referring now to FIG. 6, there is shown an exemplary embodiment of the present invention. The system is housed within a support 11, which is a closed housing 40 that supports a lockable device container 41 thereabove. The lockable container 41 is preferably a key-lockable 44 structure that includes an interior volume adapted to support a wireless device 100 therein and provide electrical connectivity 31 therewith. The connector 31 supplies power and controls the operation of the device 100 while therein, while the locking capability 44 prevents a driving user from accessing the container while the vehicle is in operation. In one embodiment, the keys 45 for the lock 44 may be the same as those required for the vehicle ignition. To install the device within a vehicle, the base 40 is placed on a relatively flat surface (vehicle dash, center console, etc.) and the electrical power connector 43 is connected to a DC power supply therein. The power connector 43 is preferably a removable DC connector that draws power from a cigarette lighter receptacle.

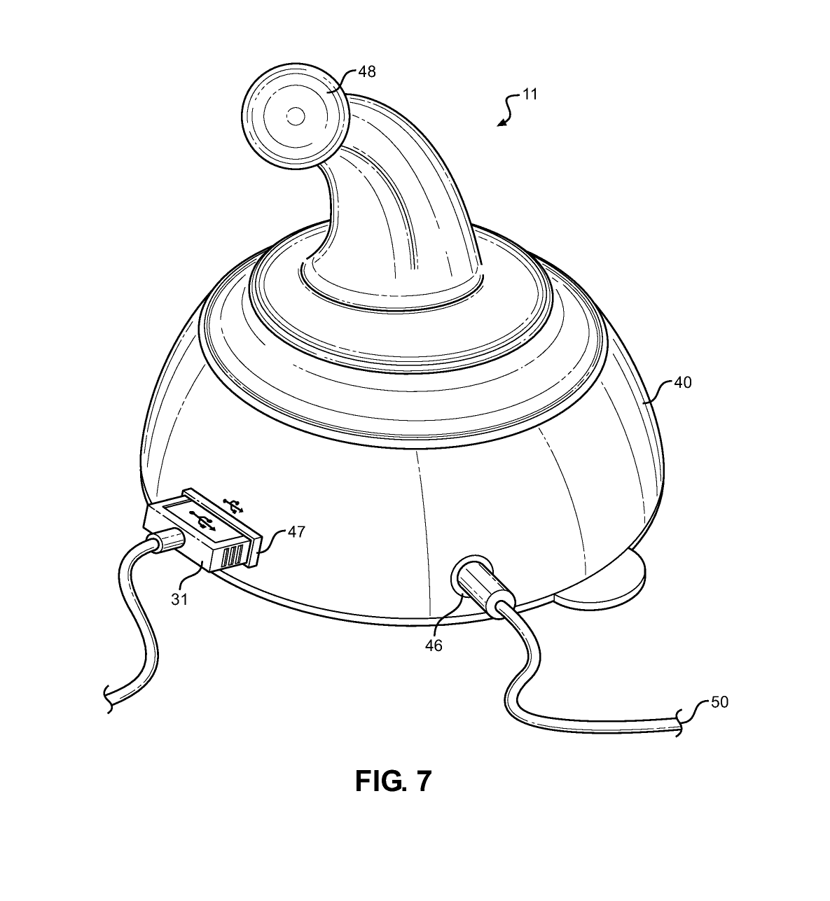

Referring finally to FIG. 7, there is shown a perspective view of the support 11 of the present invention, without the installed device container thereabove. The support 11 comprises a weighted housing 40 that protects and surrounds the electrical elements of the present system. Along the housing are a first power supply port 46 and an electrical connector interface 47. The power supply port 46 connects to the vehicle's power supply 50 and routes power into the system. The electrical connector interface 47 preferably comprises a USB connection interface for a connector 31 to send electrical power and commands to the attached wireless device. Along the upper portion of the housing 40 is a connection means 48 to the wireless device container, which supports the wireless device while driving in a locked and stable configuration while the system controls its operation through the electrical connector 31.

Many people use their cellular phones while driving, even where there are laws that prohibit them from doing so. When drivers, especially young or inexperienced drivers, are distracted by these wireless devices, they are more likely to become involved in a vehicular accident or crash. Unfortunately, many of these accidents are fatal, and all are unwanted and expensive. Some people may turn off their phone when they are driving, but others who attempt to contact them may become worried that their phone is completely shut off.

To resolve this problem, the present invention provides a system to prevent drivers from being distracted by a cell phone while driving. The device comprises a lockable container that charges the wireless device and controls its operation while thereattached. The system is preferably deployed within a device mounted on the dashboard. A driving user places their wireless device within the container and connects the device to the system by way of the electrical connector. Once connected, the system locks the screen of the wireless device and responds automatically to incoming messages and calls, while at the same time charging the device using vehicle power. This prevents users from engaging in any cell phone activity while driving, thereby reducing the number of distracted-driving accidents and fatalities. The system is ideal for parents who want to monitor their teenage sons and daughters while driving, or for anyone else simply looking for a safe way to drive.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wireless device driving deactivation system, comprising:
a housing having a processing means;
a memory;
an electrical peripheral interface; and
a storage means;
a power connection means adapted to receive power from a vehicle electrical system;
a wireless device support adapted to support a wireless device;
said wireless device support having a lockable interior volume;
an electrical connector between said electrical peripheral interface and said wireless device.

2) A method of deactivating a wireless device with the system of claim 1, comprising the steps of:
detecting a connected wireless device;
locking said wireless device display screen;
deactivating audible, vibratory, and visual notifications from said wireless device;
diverting all incoming calls to a voice message system;
returning all incoming messages with a message indicating a driving condition;
charging said wireless device battery.

3) The method of claim 1, further comprising the steps of:
determining if a message sender is unique;
sending a return message to all unique messengers.

4) The method of claim 1, wherein:
said voice message system has a unique message to callers alerting a caller of a driving condition.
